(19) United States
(12) Patent Application Publication
(10) Pub. No.: US 2012/0285539 A1
(43) Pub. Date: Nov. 15, 2012

(54) MULTIPLE-USE AQUIFER-BASED SYSTEM

(76) Inventor: William Riley, New Haven, CT (US)

(21) Appl. No.: 13/349,872

(22) Filed: Jan. 13, 2012

Related U.S. Application Data
(60) Provisional application No. 61/484,308, filed on May 10, 2011.

(51) Int. Cl. F17D 3/00; F17D 1/14

(52) U.S. Cl. 137/1; 137/565.11; 137/551

(57) ABSTRACT

A method of operating a multiple-use, aquifer-based system includes pumping fluid out of an aquifer (or multiple aquifers) with a pump and selectively diverting the pumped fluid to a pumped-storage reservoir for subsequent return to the aquifer through a turbine to generate electricity hydroelectrically or to a fluid-utilizing system configured to utilize the pumped fluid in an application that is not related to the hydroelectric generation.

### CROSS-REFERENCE TO RELATED APPLICATION(S)

This application claims the benefit of U.S. Provisional Patent Application Ser. No. 61/484,308, filed May 10, 2011, which is hereby incorporated by reference in its entirety.

### FIELD OF THE INVENTION

The present disclosure relates to an aquifer-based system and, more particularly, relates to a multiple-use aquifer-based system.

### BACKGROUND

Aquifers are naturally-occurring layers of permeable rock or unconsolidated materials that are capable of bearing fluid and/or do bear fluid. Groundwater can be usefully extracted from an aquifer using a water well.

### SUMMARY OF THE INVENTION

In one aspect, a method includes operating an aquifer-based system by pumping fluid out of an aquifer with a pump; and selectively diverting the pumped fluid: to a pumped-storage reservoir for subsequent return to the aquifer through a turbine to generate electricity hydroelectrically; or to a fluid-utilizing system configured to utilize the pumped fluid in an application that is not related to the hydroelectric generation. In some implementations, the method further includes providing an indication at a remotely-located indicator as to whether the aquifer-based system is available to generate electricity hydroelectrically. The availability of the aquifer-based system to generate electricity hydroelectrically may depend, at least in part, on whether the pump is currently pumping the fluid out of the aquifer. The availability of the aquifer-based system to generate electricity hydroelectrically may depend, at least in part, on whether a local operator has reserved the aquifer-based system, at a local controller, for use in connection with the fluid-utilizing system only.

In some implementations, the method includes providing a remotely-located controller that can be manipulated to cause a portion of the pumped fluid in the pumped-storage reservoir to return to the aquifer through the turbine substantially under the influence of gravity, if the aquifer-based system has been indicated as being available to generate electricity hydroelectrically.

According to a typical implementation, the method includes releasing the portion of the pumped fluid in the pumped-storage container to return to the aquifer through the turbine and thereby generate electricity in response, for example, to a manipulation of the remotely-located controller.

Certain embodiments include preventing the remotely-located controller from causing the portion of the pumped fluid in the pumped-storage reservoir to return the aquifer through the turbine, unless the aquifer-based system has been indicated as being available to generate electricity hydroelectrically.

According to some implementations, selectively diverting the pumped fluid includes: configuring one or more valves connected between the pump and the pumped-storage reservoir and between the pump and the fluid-utilizing system.

Operation of the pump may be timed to pump the aquifer fluid to the pumped-storage reservoir when off-peak rates apply for the purchase of electrical power to run the pump.

The fluid-utilizing system can be, for example, an irrigation system, a drinking water system, a heating water system or a cooling water system.

The pump and the turbine are, in some instances, the same machine (i.e., they form a single pump-turbine). In those instances, the return of fluid to the aquifer through the turbine to generate electricity hydroelectrically comprises allowing the fluid to flow through and drive the pump.

The aquifer is, in general, a naturally-occurring layer of porous substrate configured to contain and transmit groundwater. Moreover, the pumped-storage reservoir is a manufactured container or a natural body of fluid.

In some embodiments, the method includes maintaining a head of fluid in at least part of a fluid communication channel above the pump after the pumping has stopped.

In another aspect, a system includes: an aquifer, a pump configured to pump fluid out of the aquifer and a valve assembly. The valve assembly is configured to selectively divert the pumped fluid: to a pumped-storage reservoir for subsequent return to the aquifer through a turbine-generator for hydroelectric generation; or to a fluid-utilizing system configured to utilize the fluid in an application that is not related to the hydroelectric generation.

In some implementations, the system includes a remotely-located indicator to provide an indication as to whether the aquifer-based system is available to generate electricity hydroelectrically. The availability of the aquifer-based system to generate electricity hydroelectrically may depend, at least in part, on whether the pump is currently pumping the fluid out of the aquifer. The availability of the aquifer-based system to generate electricity hydroelectrically may depend, at least in part, on whether a local operator has reserved the aquifer-based system, at a local controller, for use in connection with the fluid-utilizing system only.

The system, in some embodiments, includes a local controller to enable the local operator to reserve the aquifer-based system for use in connection with the fluid-utilizing system (e.g., the irrigation system) only.

Some implementations include a remotely-located controller that can be manipulated to cause a portion of the pumped fluid in the pumped-storage reservoir to return to the aquifer through the turbine substantially under the influence of gravity, if the aquifer-based system has been indicated as being available to generate electricity hydroelectrically.

The valve assembly may, in some instances, be configured to release the portion of the pumped fluid in the pumped-storage container to return to the aquifer through the turbine and thereby generate electricity in response to a manipulation of the remotely-located controller. In some embodiments, the remotely-located controller is prevented from causing the portion of the pumped fluid in the pumped-storage reservoir to return the aquifer through the turbine, unless the aquifer-based system has been indicated as being available to generate electricity hydroelectrically.

In certain implementations, the valve assembly includes one or more valves connected between the pump and the pumped-storage reservoir and between the pump and the fluid-utilizing system.

The system, in some implementations, is configured so that the pump operates to pump the aquifer fluid to the pumped-storage reservoir when off-peak rates apply for the purchase of electrical power to run the pump.

The fluid-utilizing system is, for example, an irrigation system, a drinking water system, a heating water system and a cooling water system.

In some instances, the pump and the turbine are the same machine and the return of fluid to the aquifer through the turbine to generate electricity hydroelectrically includes allowing the fluid to flow through and drive the pump.

In a typical implementation, the aquifer is a naturally-occurring layer of porous substrate configured to contain and transmit groundwater and wherein the pumped-storage reservoir is a manufactured container or a natural body of fluid.

Certain embodiments include a valve that is operable to maintain a head of fluid in at least part of (or all of) the fluid communication channel above the pump-turbine 110 when the pump is idle.

In yet another aspect, a network includes multiple aquifer-based systems. Each aquifer-based system includes an aquifer, a pump configured to pump fluid out of the aquifer and a valve assembly. The valve assembly is configured to selectively divert the pumped fluid: to a pumped-storage reservoir for subsequent return to the aquifer through a turbine-generator for hydroelectric generation; or to a fluid-utilizing system configured to utilize the pumped fluid in an application that is not related to the hydroelectric generation. The network further includes a central controller coupled to the aquifer-based systems. The central controller is configured to determine (e.g., learn) whether one or more of the aquifer-based systems is available to generate electricity hydroelectrically.

In some implementations, the network has a remotely-located indicator to provide an indication as to whether each of the aquifer-based systems is available to generate electricity hydroelectrically. The availability of each aquifer-based system to generate electricity hydroelectrically may depend, at least in part, on whether the pump of that aquifer-based system is currently pumping the fluid out of the aquifer. The availability of each aquifer-based system to generate electricity hydroelectrically may depend, at least in part, on whether a local operator has reserved that aquifer-based system, at a local controller, for use in connection with the fluid-utilizing system only.

According to certain embodiments, the network has one or more local controllers, each of which is enable the local operator associated with that local controller to reserve the aquifer-based system for use in connection with the fluid-utilizing system.

In some implementations, a central controller is able to be manipulated to cause in one or more of the aquifer-based systems that have been indicated as being available to generate electricity: a portion of the pumped fluid in the pumped-storage reservoir to return to the aquifer through the turbine substantially under the influence of gravity.

According to some embodiments, in each of the aquifer-based systems: the valve assembly is configured to release the portion of the pumped fluid in the pumped-storage container to return to the aquifer through the turbine and thereby generate electricity in response to a manipulation of the central controller.

In certain implementations, for each aquifer-based system that has not been indicated as being available to generate electricity hydroelectrically, the central controller is prevented from causing the portion of the pumped fluid in the pumped-storage reservoir to return the aquifer through the turbine.

In some implementations, for each aquifer-based system, the valve assembly has one or more valves connected between the pump and the pumped-storage reservoir and between the pump and the fluid-utilizing system.

In some implementations, for each aquifer-based system, the aquifer-based system is configured so that the pump operates to pump the aquifer fluid to the pumped-storage reservoir when off-peak rates apply for the purchase of electrical power to run the pump.

In some implementations, for each aquifer-based system, the fluid-utilizing system is an irrigation system, a drinking water system, a heating water system or a cooling water system.

For one or more of the aquifer-based systems, the pump and the turbine may be the same machine (i.e., a pump-turbine) such that the return of fluid to the aquifer through the turbine to generate electricity hydroelectrically comprises the fluid flowing through and driving the pump.

In a typical implementation, the aquifer is a naturally-occurring layer of porous substrate configured to contain and transmit groundwater and wherein the pumped-storage reservoir is a manufactured container or a natural body of fluid.

The central controller can be configured to operate more than one of the aquifer-based systems to generate electricity hydroelectricity at the same time.

In yet another aspect, a method includes identifying an existing system configured to pump fluid out of an aquifer to a fluid-utilizing system, providing a pumped-storage container at an elevation higher than the fluid in the aquifer and providing a valve assembly to selectively divert fluid pumped by the pump. The selective diversion is either to the pumped-storage reservoir for subsequent return to the aquifer through a turbine-generator for hydroelectric generation or to the fluid-utilizing system. The fluid-utilizing system is configured to utilize the pumped fluid in an application that is not related to the hydroelectric generation (e.g., for irrigation).

In some implementations, the method includes providing a remotely-located indicator to indicate whether the aquifer-based system is available to generate electricity hydroelectrically. The availability of the aquifer-based system to generate electricity hydroelectrically may depend, at least in part, on whether the pump is currently pumping the fluid out of the aquifer. The availability of the aquifer-based system to generate electricity hydroelectrically may depend, at least in part, on whether a local operator has reserved the aquifer-based system, at a local controller, for use in connection with the fluid-utilizing system only.

In certain embodiments, the method includes providing a remotely-located controller that can be manipulated to cause a portion of the pumped fluid in the pumped-storage reservoir to return to the aquifer through the turbine substantially under the influence of gravity, if the aquifer-based system has been indicated as being available to generate electricity hydroelectrically.

In certain embodiments, the method includes releasing the portion of the pumped fluid in the pumped-storage container to return to the aquifer through the turbine and thereby generate electricity in response to a manipulation of the remotely-located controller.

In certain implementations, the method includes preventing the remotely-located controller from causing the portion of the pumped fluid in the pumped-storage reservoir to return the aquifer through the turbine, unless the aquifer-based system has been indicated as being available to generate electricity hydroelectrically.

In certain implementations, the method includes timing operation of the pump to pump the aquifer fluid to the pumped-storage reservoir when off-peak rates apply for the purchase of electrical power to run the pump.

In certain embodiments, the fluid-utilizing system is an irrigation system, a drinking water system, a heating water system or a cooling water system. Moreover, the pump and the turbine may be the same machine (e.g., a pump-turbine) and the return of fluid to the aquifer through the turbine to generate electricity hydroelectrically includes allowing the fluid to flow through and drive the pump.

In a typical embodiment, the aquifer is a naturally-occurring layer of porous substrate configured to contain and transmit groundwater and wherein the pumped-storage reservoir is a manufactured container or a natural body of fluid.

In some implementations, one or more of the following advantages are present.

For example, a multiple-use, aquifer-based system may be provided in which one or more aquifers is used as a reservoir in a pumped storage generation system, either in connection with another aquifer or with a surface container such as a pond or tank, for example. In such a system, water can be pumped from a lower elevation to a higher elevation when power is available and relatively inexpensive, then allowed to flow from the higher elevation to a lower elevation (e.g., the original source aquifer or another aquifer through a turbine or pump-turbine configured to drive a generator for electrical generation, when power is needed. It is believed that substantial quantities of electricity could be stored and generated by such a system.

Moreover, the multiple-use aquifer-based system can be configured to supply aquifer fluid for other purposes besides pumped-storage generation (substantially unrelated to pumped-storage generation). These functions can include, for example, irrigation, supplying water for cooling purposes or heating purposes, etc.

Thus, a single installation can be used to perform two or more functions and to alternate according to convenience or the like between the two or more functions.

In some implementations, the multiple-use aquifer-based system can be constructed in a highly cost effective manner by converting an existing irrigation system, for example, to the multiple-use, aquifer-based system. Such wells are already in existence and have been permitted for withdrawal of large quantities of water. There are many of them (according to some estimates, approximately 70,000 in Texas.) Because the exploratory work, drilling and completion of the wells have already been accomplished, a large portion of the development and capital cost of the wells already has been incurred. The cost to convert would likely be comparatively low.

Moreover, many existing well pumps can be modified at a nominal expense to serve as pump-turbines and adapted to generate electricity when fluid is permitted to flow through them in a direction opposite the pumping direction. As irrigation wells, these units are generally only in use part of the year, and even in that time, typically only part of each day. There are other large-scale wells, such as those used for municipal and industrial use that also may be appropriate, and smaller-scale wells, such as those used for individual water supply, may also be useful, but irrigation wells offer the combination of existing high volume wells scheduled for use at predictable times, two desirable characteristics. Also in many cases the construction of surface storage tanks or reservoirs in connection with the pumps could be readily accommodated as they are generally located in rural areas.

Additionally, in some implementations, a plurality of multiple-use aquifer-based systems may be connected in a network to serve in effect as a large and supple “virtual” energy pumped storage reservoir. At any given moment, one or many of the wells may be in use, but one or many of them may also be available. In their aggregate such wells could contain large quantities of ready water storage, equivalent to large quantities of nearly instant-on electrical pumped storage capacity.

In some implementations, through telemetry a network or grid operator could determine whether a given well was in operation or not. If it was, the operator would go on to the next well. If it was not, it would be available for use. In large parts of the year, this might not be required, as the well and pump are scheduled to be idle, but in times when the well might be in use the state of the well could be determined, for example, by a telemetered “query” as to whether the well was on (using power) or idle (not using power).

In some implementations, if a local operator (e.g., a farmer) needs to use the well for irrigation purposes, for example, during a period of time when the well is being used for pumped-storage generation purposes, generally, the local operator would be able to do so, for example, by manipulating an override switch at a local controller. In a typical implementation, manipulating the override switch changes the use from a turbine (producing power) to a pump (producing water), and under these circumstances, the grid operator could go onto another well and activate it for use in connection with pumped-storage generation, if desired.

In a typical implementation, during idle periods of time, the pumped-storage containers (usually a surface tank or reservoir) would be kept full or close to full by use of off-peak or other low cost power (such as excess intermittent power from wind or solar sources).

When needed, a valve assembly would be manipulated to allow the water from the pumped-storage container to flow down through the well bore, and through the pump-turbine, thereby producing electrical power. At times when excess or low-cost power was available, the system could be activated to use the pump mode of the pump-turbine to refill the surface storage container.

When not needed, as during non-irrigating times of year, the container could be isolated from the irrigation or other water-using facility, to be retained solely for power generation. By appropriate agreement between the well operator and the grid operator, the well could be used for pumped-storage purposes when it is not needed or wanted for watering purposes. The combination of such agreements and telemetry to determine the status of the well and provide an override capability to its owner would provide optimal total use of the well, sometimes for irrigation purposes, for example, and sometimes for hydroelectric pumped-storage generation.

In a typical implementation, the network of multiple-use aquifer-based systems can provide a large (e.g., many megawatt), almost instantly available source of stored electrical energy at a highly competitive cost. Because the system would be made up of many, rather than one or a few storage elements, it would be more resilient and robust. Moreover, because some of the aquifer-based systems could be converted from irrigation systems, for example, the associated construction costs for the system would be relatively low.

The electrical power produced by such a system is highly environmentally friendly. In a typical implementation, such a system would make feasible much greater use of intermittent power and thereby reduce demands for fossil fuels, which produce CO2 as a waste product.

While such a system would allow for very large power generating storage, the almost instant-on characteristic of a pumped storage system would also provide efficient short-term (e.g., seconds to minutes) power storage and generation.

Other features and advantages will be apparent from the description and drawings, and from the claims.

### BRIEF DESCRIPTION OF THE DRAWINGS

FIG. 1 is a schematic diagram of an exemplary multiple-use, aquifer-based system.

FIG. 2 is a schematic diagram of a network of exemplary multiple-use, aquifer-based systems.

FIG. 3 is a schematic representation of an exemplary local control panel for an aquifer-based system.

FIG. 4 is a schematic representation of an exemplary central control panel for a network of multiple-use, aquifer-based systems.

FIG. 5 is a flowchart showing a method of converting an existing well system to a multiple-use, aquifer-based pumped-storage generation system.

FIG. 6 is a schematic diagram of a network of exemplary multiple-use aquifer-based systems.

Like reference numerals refer to like elements.

### DETAILED DESCRIPTION

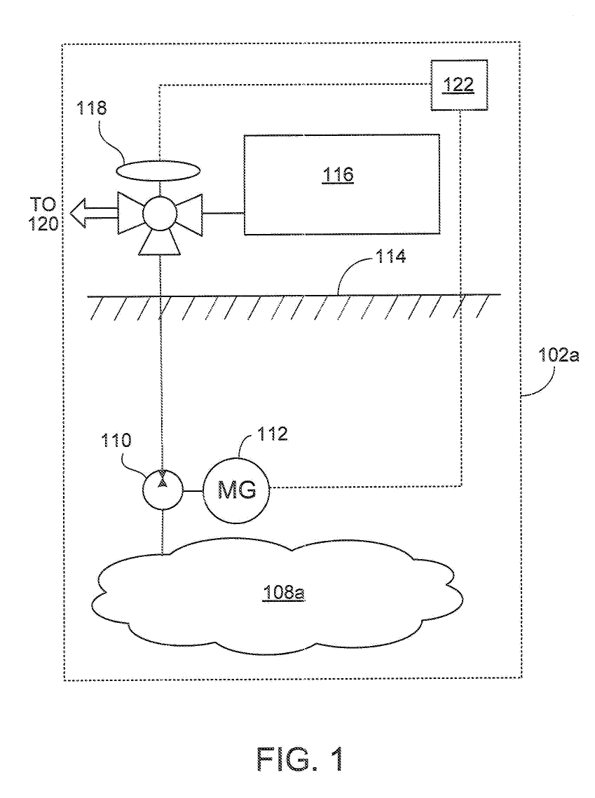

FIG. 1 illustrates an exemplary multiple-use, aquifer-based electrical power generation system 102a. The multiple uses of the illustrated system 102a include pumped-storage hydroelectric generation and irrigation. More particularly, the illustrated system 102a is adapted to selectively utilize fluid from the aquifer 108a in connection with either pumped-storage hydroelectric generation or irrigation purposes.

The illustrated system 102a includes a pump-turbine 110 configured to operate as either a pump or a turbine. In pump mode, the pump-turbine 110 can pump fluid out of the aquifer 108a to an irrigation system 120 or a pumped-storage tank 116. In turbine-mode, the pump-turbine 110 can be driven by fluid flowing through it in a direction that is opposite its pumping direction.

The illustrated pump-turbine 110 is coupled to a motor-generator 112 via a drive shaft. The motor-generator 112 is configured to operate as a motor or a generator. In motor mode, the motor-generator 112 drives the pump-turbine 110 to pump the aquifer fluid. In generator mode, the motor-generator is driven by the pump-turbine 110 and generates electricity.

A three-way valve 118 is coupled to the pump-turbine 110. More particularly, the three-way valve 118 is configured to selectively divert aquifer fluid pumped by the pump-turbine 110 to either the pumped-storage container 116 or the irrigation system 120. In a typical implementation, the three-way valve also is configured to selectively divert aquifer fluid flowing out of the pumped-storage container 116 to either the irrigation system 120 or to the pump-turbine 110.

Although the illustrated system 102a includes a three-way valve 118 to perform this function, the system could readily be adapted to use any other kind of valve arrangement in place of the three-way valve 118 to selectively divert the pumped fluid. For example, in some implementations, two, three or more valves may be configured to perform at least substantially similar to the illustrated three-way valve 118.

The three-way valve 118 or other valve arrangement may be hand-operable or may be operable in response to a control signal (e.g., a pneumatic or electrical signal) that is generated either automatically or in response to input from a human operator (e.g., the farmer).

The pumped-storage container 116 can be a manufactured container or any kind of fluid collection area that is capable of receiving and storing a fluid. For example, the pumped-storage container 116 can be a pond, a lake, a tank, a second aquifer, etc.

The irrigation system 120 can be configured in a variety of ways and is generally adapted to utilize the aquifer fluid to irrigate crops. For example, the irrigation system may include one or more storage tanks, pumps, fluid communication channels and water distribution devices (e.g., sprinklers) to facilitate irrigation.

Fluid communication channels (represented by solid lines in FIG. 1), such as pipes, tubes or the like, extend between and connect the pump-turbine 110, aquifer 108a, three-way valve 118, pumped-storage container 116 and irrigation system 120 as shown.

A local controller 122 is configured to communicate with the three-way valve 118 and the motor-generator 112 via communication channels (represented by dashed lines), such as wired or wireless communication channels.

In a typical implementation, the local controller 122 is operable to enable a local operator (e.g., a farmer) to control the position of the three-way valve 118 and to control at least certain operations associated with the motor-generator 112. Buttons, switches, knobs and/or other control elements may be provided at the local controller 122 to facilitate these functionalities. In some implementations, the local controller 122 provides automatic control over various aspects of system operation.

In the illustrated implementation, the pumped-storage container 116, the three-way valve 118 and the local controller 122 are all above ground 114, whereas the pump-turbine 110 and motor-generator 112 are below ground. This relative arrangement exists in some implementations, but is not required. However, in general, the pumped-storage container 116 should be located at a high enough elevation relative to the aquifer 108a so that fluid is able to flow, when permitted to do so, substantially under the influence of gravity, from the pumped storage container 116 to the aquifer 108a, passing through the pump-turbine 110 to drive the motor-generator 112 along the way.

In a typical implementation, the pump-turbine 110 (and motor-generator 112) is physically located inside a well that is associated with the aquifer 108a.

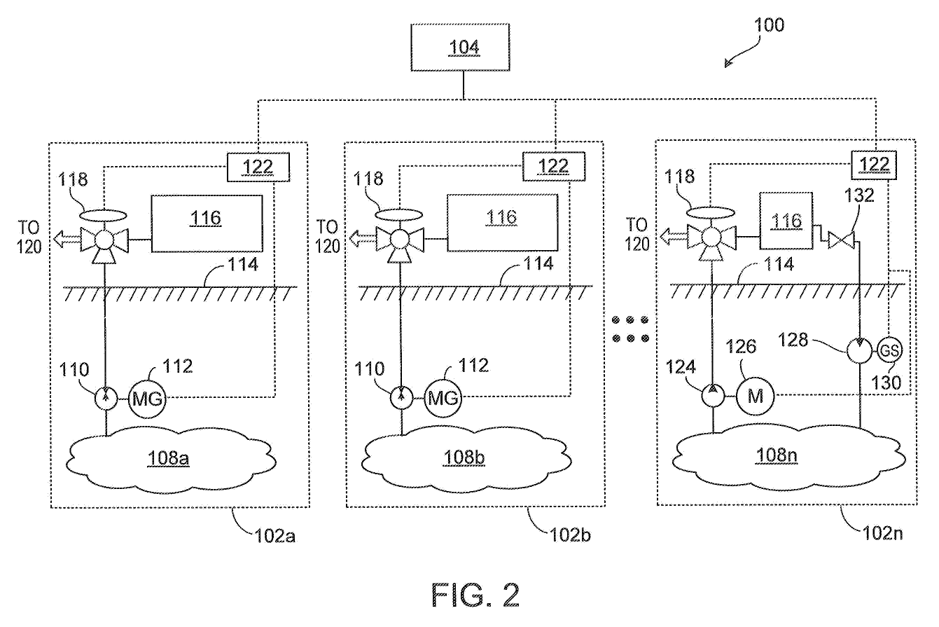

In some implementations, the local controller 122 is also adapted to communicate with a remote controller (see, e.g., 104 in FIG. 2). In such instances, as discussed below, the remote controller may be adapted to control and/or monitor over certain operational aspects of the system. In some instances, the remote controller may also be adapted to control and/or monitor certain operational aspects of other aquifer-based multiple-use systems that are adapted to hydroelectrically generate electricity using aquifer fluid.

The illustrated system 102a can be operated in a variety of ways.

For example, in one operating mode, the system 102a operates to provide aquifer fluid to the irrigation system 120. When the system 102a is being operated to provide aquifer fluid to the irrigation system, the motor-generator 112 operates to drive the pump-turbine 110 to pump fluid out of the aquifer 108a and up to the three-way valve 118. The three-way valve 118 is configured to selectively divert the pumped fluid to the irrigation system 120.

In another operating mode, the system 102a operates to charge the pumped-storage container 116 with fluid. In this operating mode, the motor-generator 112 drives the pump-turbine 110 to pump fluid out of the aquifer and up to the three-way valve 118. The three-way valve 118 selectively diverts the pumped fluid to the pumped-storage container 116.

In some implementation, the fluid level in the pumped-storage container is monitored so that the pumping can be stopped, for example, when the fluid in the pumped-storage container reaches a predetermined level. To stop pumping, in a typical implementation, the pump-turbine 110 is stopped and the three-way valve 118 is moved to a position to prevent backflow of aquifer fluid out of the pumped-storage container 116.

In some implementations, the system is operable maintains a head of fluid in at least part of (or all of) the fluid communication channel above the pump-turbine. In a typical implementation, this can be achieved by closing a valve either above (but near) or below the pump-turbine after pumping has been stopped. Maintaining a head of fluid in this manner helps the system to begin producing electricity nearly immediately upon an indication that electricity production is desired.

Moreover, with the system primed in this manner to begin producing electricity nearly immediately, the amount of time that irrigation may need to be interrupted in order to produce a requisite amount of electricity may be reduced. In some instances, the shorter duration of interruption to irrigation may make the interruption more acceptable to the owner or operator of the irrigation system than a longer duration interruption would be.

In certain embodiments, a level indicator is provided at the local controller (and/or at the remote controller) to indicate when the fluid has reached the predetermined level. The indicator can be, for example, an audible, visual or tactile indicator.

In another operating mode, the system 102a operates to generate hydroelectric power. In this operating mode, the three-way valve 118 is positioned to establish a fluid communication path between the pumped-storage container 116 and the pump-turbine 110. Fluid is permitted to flow, substantially under the influence of gravity, from the pumped-storage container 116 through the pump-turbine 110 and into the aquifer 108a. In some implementations, the fluid flowing out of the pumped-storage container is helped along by a booster pump (not shown).

The fluid flowing out of the pumped-storage container 116 drives the pump-turbine 110, which in turn drives the motor-generator 112 to produce electricity.

In a typical implementation, any electricity produced by the motor-generator is fed into an electrical power system, typically to supplement one or more primary power generating systems supplying electricity to the electrical power system. Also, in a typical implementation, the system 102a is operated to produce electricity during periods of relatively high demand on the electrical power system.

In another operating mode, the system 102a operates to supply fluid from the pumped-storage container 116 to the irrigation system 120. In this operating mode, the three-way valve 118 is positioned to establish a fluid communications path between the pumped-storage container 116 and the irrigation system 120. The pump-turbine 110/motor-generator 112 generally remains idle during such times. In most instances, however, the system 102a would not be operated to use fluid from the pumped-storage container 116 for irrigation purposes. In most instances, the system 102a would be operated to keep the stored fluid in the pumped-storage container until and unless the fluid is needed to drive the pump-turbine 110 for electrical power generation purposes.

In some implementations, a booster pump (not shown) may be provided to facilitate fluid flow out of the pumped-storage container 116 to the irrigation system 120. However, in some implementations, the fluid flows from the pumped-storage container 116 to the irrigation system 120 substantially under the influence of gravity.

FIG. 2 illustrates a network 100 of multiple-use, aquifer-based systems 102a, 102b . . . 102n, each of which is adapted to utilize fluid from an associated aquifer in connection with hydroelectric pumped-storage generation and for one or more other purposes, such as irrigation, that are unrelated to the hydroelectric pumped-storage generation. Typically, the purpose that is unrelated to the hydroelectric pumped-storage generation is one that primarily benefits a local operator of the aquifer-based systems 102a, 102b . . . 102n in the way that irrigation would benefit a local farmer, for example.

One of the aquifer-based systems 102a in FIG. 2 is the aquifer-based system 102a of FIG. 1, which is discussed in detail above. Another one of the aquifer-based systems 102b is substantially identical to aquifer-based system 102a.

The third one of the aquifer-based systems 102n shown in the figure differs from the other two aquifer-based systems 102a, 102b in a few ways.

For example, aquifer-based system 102n has two separate wells extended from the earth's surface down to the aquifer 108n. A pump 124 coupled to and driven by a motor 126 is physically located in one of the wells and a separate turbine 128 coupled to and configured to drive an electrical generator 130 is physically located in the other well. Additionally, the valve arrangement in aquifer-based system 102n includes not only valve 118, but also valve 132, which opens and closes to control the flow of fluid, substantially under the influence of gravity from the pumped-storage reservoir 116, through the turbine 128 and into the aquifer 108n. Despite these differences, the third aquifer-based system still is generally operable to perform multiple functions like the other aquifer-based systems 102a, 102b.

In a typical implementation, the network 100 includes a large number of aquifer-based systems, which may differ in a variety of ways from one another.

The illustrated network 100 is generally configured such that, for each aquifer-based system 102a, 102b . . . 102n, certain aspects of system operation can be controlled locally with a local controller 122 and certain aspects of system operation can be controlled remotely (e.g., from central controller 104, which, in the illustrated example, is configured so that it can control certain operational aspects of each respective one of the aquifer-based systems 102a, 102b . . . 102n). Certain aspects of system operation may be controllable from both the local controller 122 and the central controller 104.

Typically, each local controller 116 is exclusively accessible by a local operator (e.g., a farmer who owns and/or operates the irrigation system 120), whereas the remote (central) controller 104 is exclusively accessible by personnel associated with a central operator (e.g., a public electrical utility company).

In a typical implementation, the network 100 and each respective one of the aquifer-based systems 102a, 102b . . . 102n is operated according to terms that are agreed upon between the central operator on one hand and each respective one of the local operators on the other hand. This agreement may be in the form of a formal written agreement, an informal verbal agreement or any other kind of agreement between the relevant parties.

Various aspects of network and system operations can be automated and, in some implementations, the central controller 104 and one or more of the local controllers 122 can be programmed to implement or facilitate one or more of the agreed-upon operating terms.

In some instances, an operating agreement is established between the central operator and an associated local operator at the time when the local operator's aquifer-based system is built (or converted from being a single-use (e.g., irrigation) system to a system that also provides pumped-storage hydroelectric generation). Typically, this would include the central operator and the local operator negotiating operating terms and establishing a set of rules by which the resources of the new or converted system could be shared.

The operating agreement may be structured in a variety of ways. However, the operating agreement typically sets forth the rights and obligations of each party in connection with the shared usage of the associated system (e.g., 102a).

In some operating agreements, for example, specific times of the day or specific weeks or months may be designated when the central operator is free to remotely control the aquifer-based system for use in connection with functions associated with pumped-storage generation. These periods of time typically would correspond with periods of time when the local operator would not be using the aquifer-based system for irrigation purposes.

Additionally, according to some operating agreements, the central operator may be permitted to remotely interrupt operations associated with the non-pumped storage generation functionality (e.g., irrigation) for certain small amounts of time (e.g., 10 minutes, 15 minutes or 30 minutes) on an as needed basis. This may be acceptable, for example, if the crops that are irrigated by the irrigation system 120 can tolerate relatively small interruptions in their irrigation, which is generally true.

In some implementations, the central controller 104 and/or one or more of the local controllers 122 are programmed to either implement or facilitate functionality of the network 100 and one or more of the aquifer-based systems 102a, 102b . . . 102n according to the terms of the operating agreement.

Moreover, in some implementations, the central controller 104 is operable to determine which, if any, of the aquifer-based systems 102a, 102b . . . 102n is available, at a given time, for operations related to hydroelectric pumped-storage functionalities. This determination may be made in a number of ways.

For example, the determination may be made by virtue of the central controller 104 communicating with one or more of the local controllers at the aquifer-based systems 102a, 102b . . . 102n. Communication may be conducted via telemetry, for example. In a particular example, the central controller 104 would issue one or more inquiries regarding the status of the respective aquifer-based systems and each respective one of the local controllers that receives the inquiry can respond via telemetry, for example, with an indication of whether the associated aquifer-based system is available to perform functions associated with pumped-storage generation.

In other implementations, each local controller 122 may be adapted to periodically report to the central controller 104 on whether the associated aquifer-based system is available to perform functions associated with pumped-storage generation. In this example, the central controller 104 may be adapted to maintain a running tally of statuses for the aquifer-based systems 102a, 102b . . . 102n in the network 100.

In some implementations, the central controller 104 may include logic that enables it to determine on its own whether a particular one or more of the aquifer-based systems is available to perform functions associated with pumped-storage generation.

The logic implemented by the central controller 104 may, for example, be based on the terms of the operating agreement between the central operator and the corresponding local operator. For example, an operating agreement may have specified that an aquifer-based system would be available to perform functions associated with pumped-storage generation during winter months when the aquifer-based system was not needed for irrigation purposes. In that instance, the central controller may include logic that enables it to determine when the winter months are occurring.

In general, one of the aquifer-based systems may be considered available to perform functions associated with pumped-storage generation when it is not currently being used (and/or not currently being reserved for) any other purpose. In this regard, in some implementations, the local controller 122 in one or more of the aquifer-based systems may include a control element (e.g., a switch, a knob, a button or the like) that enables the local operator to designate its aquifer-based system as being available or unavailable to perform functions associated with pumped-storage generation. Thus, the local operator, in those instances, has the option to override any other indication that the aquifer-based system may be available for such use.

Functions related to pumped-storage generation can include a variety of different functions, some of which may include, for example: (a) pumping fluid out of an associated one of the aquifers (i.e., 108a, 108b . . . 108n) to an associated one of the pumped storage containers (i.e., 116); or (b) releasing fluid from one of the pumped storage containers to flow substantially under the influence of gravity to an associated aquifer passing through a turbine-generator along the way.

In a typical implementation, if the central controller 104 determines that one or more of the aquifer-based systems is available for operations related to pumped-storage generation, then the central controller 104 enables the central operator to access this information. Access to this information may be provided in a number of different ways. For example, the central controller 104 may provide an indication to the central operator using a visual, audible or tactile indicator provided on or near the central controller itself. Alternatively, the central controller may enable the central operator to access this information at a computer terminal either on or coupled to the central controller.

In a typical implementation, the central controller 104 enables control over one or more aspects of system operation for any one of the aquifer-based systems 102a, 102b . . . 102n that are available for operations related to pumped-storage generation. The specific control functionality that the central controller 104 possesses in this regard can vary considerably. However, in some implementations, the control functionality includes: (a) pumping fluid out of an associated one of the aquifers (i.e., 108a, 108b . . . 108n) to an associated one of the pumped storage containers (i.e., 116); or (b) releasing fluid from one of the pumped storage containers to flow substantially under the influence of gravity to an associated aquifer passing through a turbine-generator along the way.

In general, any electrical power that is generated by one of the aquifer-based systems 102a, 102b . . . 102n is routed to an electrical power system that is operated by the central operator or by some other entity. The generated electrical power can supplement other electrical power that is being produced, for example, by other electrical power generating systems, one or more of which may or may not be aquifer-based. This can be especially helpful during times when the load on the electrical power system is particularly high.

There are a number of ways in which the network 100 can be advantageously operated.

For example, in a typical implementation, the local operator, typically a farmer has a superior right over the central operator (e.g., the public utility company) to use its associated aquifer-based system for irrigation purposes. The local operator's use of system, however, typically is intermittent (i.e., not indefinitely continuous). The central operator (e.g., the public utility company) typically operates and monitors the time-varying demand on an electrical power system.

During periods of relatively high demand on the electrical power system, the central operator may utilize the network to determine which, if any, of the aquifer-based systems is available for operations related to pumped-storage generation. Then, for one or more of the aquifer-based systems that the central operator determines is available for operations related to pumped-storage generation, the central operator uses the central controller to manipulate the three-way valve to release fluid from the pumped-storage container to flow through the turbine to the aquifer. The turbine drives the motor-generator, which produces electricity that is routed to the electrical power system to help satisfy the high demand. The central operator may use the central controller to generate electricity from multiple aquifer-based systems if, for example, the demand is particularly high.

Typically, an aquifer-based system would continue generating electricity until system demand no longer required the supplemental electricity or until the aquifer-based system's pumped-storage container no longer held a sufficient amount of fluid to produce electricity.

During periods of relatively low demand on the electrical power system and correspondingly low energy cost, the central operator, for example, could operate the pump of an aquifer-based system to replenish the fluid supply in the system's pumped-storage container.

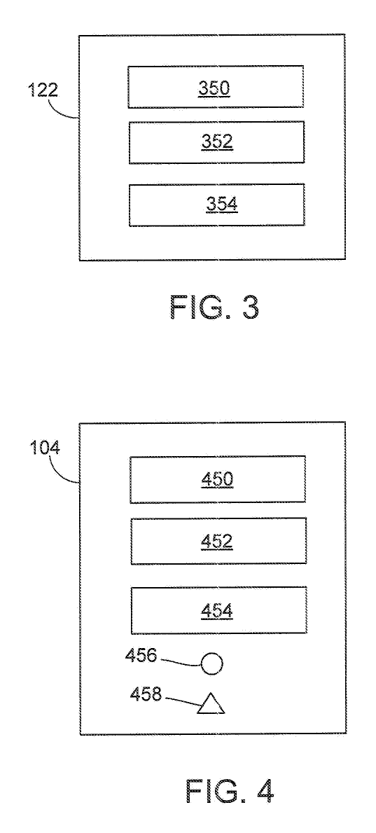

FIG. 3 shows an exemplary representation of a local controller 122 for an aquifer-based system. In the illustrated example, the local controller 122 includes one or more motor-generator control features 350 (e.g., one or more switches, knobs, buttons, or the like).

On the motor side, these control features may include features that enable the local operator to perform one or more of the following functions: turning the motor on or off, controlling the speed of the motor, or accessing other motor control functions that may typically be provided for a fluid supply pump motor.

On the generator side, these control features may include features that enable the local operator to perform one or more of the following functions: controlling the excitation voltage to the generator, regulating the rotational speed of the generator, or accessing other generator control functions that may typically be provided with a hydroelectric generator.

The illustrated local controller 122 also includes a valve position controller 352. Typically, the valve position controller at the local controller 122 enables the farmer to control the configuration of the three-way valve 118 to at least divert any fluid being pumped out of the aquifer to the irrigation system 120. In some implementations, the valve position controller at the local controller 122 also enables the farmer to control the configuration of the three-way valve 118 to selectively divert fluid from the pumped-storage container to the irrigation system 120 or to the pump-turbine 110.

FIG. 4 shows an exemplary representation of a remote (central) controller 104 for a network 100 of aquifer-based systems. In the illustrated example, the central controller 104 includes one or more control features 350 (e.g., one or more switches, knobs, buttons, or the like) to implement various aspects of control over the network.

For example, the illustrated central controller 104 includes a selector switch 458 that enables the central controller to establish contact with (including communication with and control over certain aspects of) a local controller from any one of the multiple aquifer-based systems in the network 100.

Like the local controller 122 in FIG. 3, the illustrated central controller 104 has motor/generator control features 450, a valve position controller 452 and a level indicator 454.

In a typical implementation, the motor/generator control features 450, valve position controller 452 and level indicator 454 provide control over and indications related to whichever one of the multiple aquifer-based systems in the network 100 has been selected with the selector switch.

The illustrated central controller 104 also has an availability indicator that provides a visual indication to the remote operator as to the availability of the selected aquifer-based system for functions associated with pumped-storage generation.

Many variations on control schemes and control features are possible.

In various implementations, the network 100 and operation of the network can provide a number of advantages.

For example, if fluid already has been stored in a pumped-storage container of one of the available aquifer-based systems, then the system can begin producing electrical power very quickly. This is because, in a typical system, electrical power production simply requires releasing the fluid from the pumped-storage container so that it can flow, substantially under the influence of gravity, through a turbine-generator, which begins producing electricity. The speed with which electricity can be produced can be contrasted with certain other types of electrical generating technologies (e.g., gas turbine generator systems, which typically require a fairly long warm-up period before they can start generating electricity).

Once started, the duration that a particular one of the aquifer-based systems can continue producing electricity is proportionally limited by the fluid-holding capacity of its associated pumped-storage container. The fluid-holding capacity can vary greatly. For example, in some instances, the pumped-storage container may have a large enough fluid-holding capacity that electrical power supply duration is not a significant concern. This may be so where the pumped-storage container is a lake, for example. In other instances, the pumped-storage container may have a fluid-holding capacity that is only large enough to provide a supply of water for some limited duration (e.g., 15 minutes, 30 minutes, an hour, etc.).

However, due to relatively quick availability of electrical power from one of these aquifer-based systems, even one that is only suited to produce power for a limited duration (e.g., 15 minutes) can be immensely valuable. In certain instances, a system like this could be used to provide supplemental power in situations where there has been a fast, relatively large increase in demand and it is going to take some time for another electrical generating system (e.g., a gas-turbine generating plant) to come online. In this kind of situation, one or more short duration, readily available aquifer-based hydroelectric generators can be brought online to fill in the gap between the time that the increased demand kicked in and the other, gas-turbine-based generator came online.

Moreover, in implementations of network 100 that have a very large number of aquifer-based systems 102a, 102b . . . 102n, it is highly likely that, at any given time, at least one and, more likely, many of the aquifer-based systems will be available to perform functions associated with hydroelectric generation. Thus, the availability of power and the flexibility of the network in supplying power are high.

In some implementations, the multiple-use, aquifer-based system 102a of FIG. 1 can be built around an existing aquifer. In other implementations, however, existing wells that tap into an aquifer can be converted to produce a multiple-use, aquifer-based systems adapted for pumped-storage generation and other functionalities. This can, in some instances, present a cost effective method of creating a multiple-use, aquifer-based system and/or corresponding network.

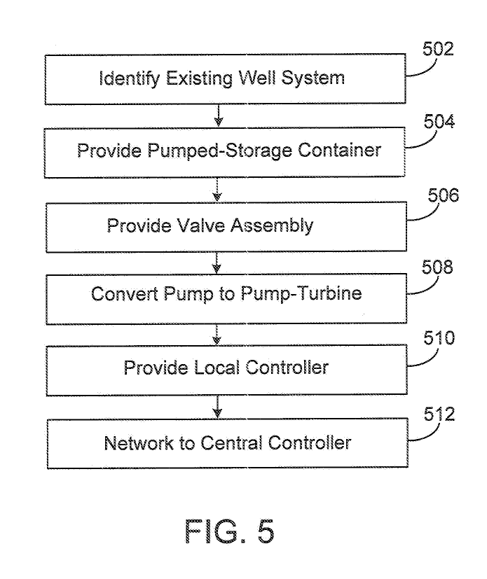

FIG. 5 represents an exemplary method of converting an existing well that taps into an aquifer into a multiple-use, aquifer-based system adapted for the pre-existing use and for pumped-storage generation and networking the converted system with other multiple-use aquifer-based systems.

The exemplary method includes identifying 502 an existing system that already includes a well with a pump configured to pump fluid out of an aquifer. Typically, this kind of system would be one that utilizes the aquifer fluid for irrigation or other purposes.

The illustrated method includes providing 504 a pumped-storage container for the system. This may include, for example, manufacturing a container or designating a nearby naturally-occurring body of fluid as a pumped-storage container. In general, the pumped-storage container is provided at an elevation that higher than the fluid in the aquifer so that fluid will be able to flow, substantially under the influence of gravity, from the pumped-storage container to the aquifer.

Next, the illustrated method includes providing 504 a valve assembly (e.g., a three-way valve 118) to selectively divert fluid pumped by the pump to the pumped-storage container for subsequent return to the aquifer through a turbine-generator for hydroelectric generation; or to the fluid-utilizing system (e.g., the irrigation system).

This step typically includes piping the three-way valve, for example, up to the pump (pump-turbine), pumped-storage container and irrigation system.

The illustrated method further includes converting 508 the existing pump into a pump-turbine. There are a variety of ways in which the existing pump may be converted into a pump-turbine. Some of the considerations in making this kind of conversion were discussed for example, in an article published by the Water World website, entitled “Using Pumps as Power Recovery Turbines,” by Allan R. Budris.

The illustrated method then includes providing 510 a local controller to control the converted system. In some instances, providing the local controller includes modifying and connecting an existing controller for enhanced functionality. In some instances, providing the local controller includes replacing an existing controller.

Finally, the illustrated method includes networking 512 the local controller to a remote controller. This includes enabling the remote controller to monitor and/or control, in certain instances, some of aspects and functionalities of the converted system.

In some implementations, the illustrated process enables the production of a converted system and the growing of an associated network of aquifer-based systems in a highly economically efficient manner, particularly as compared to the notion of building a multiple-use, aquifer-based system with only an aquifer in place.

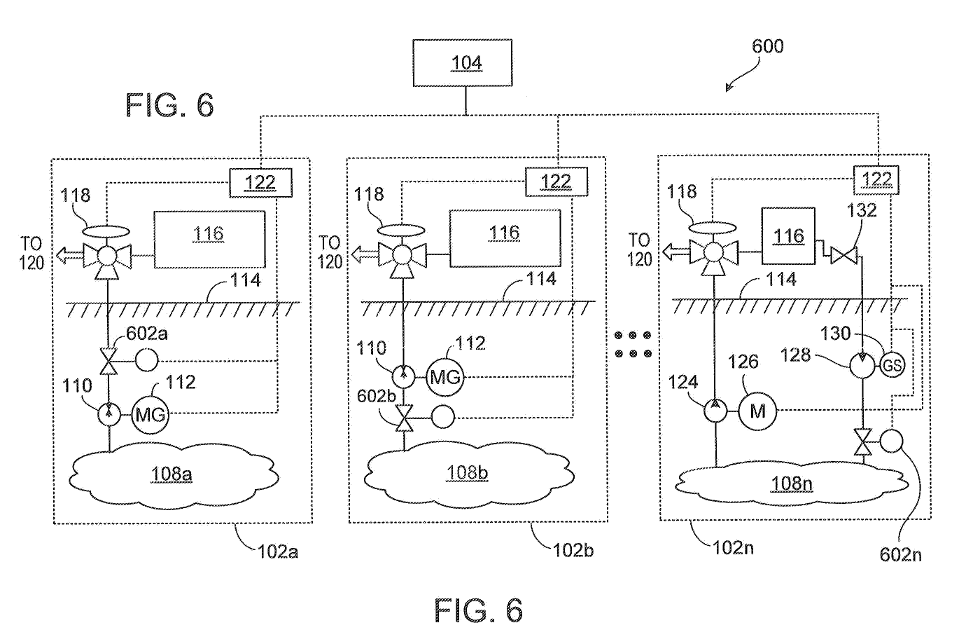

FIG. 6 illustrates an exemplary network 600 of multiple-use, aquifer-based systems 102a, 102b . . . 102n similar to the network 100 in FIG. 2, except that each aquifer-based system in the network 600 of FIG. 6 has a valve 602a, 602b . . . 602n that is operable to maintain a head of fluid in at least part of (or all of) the fluid communication channel above the pump-turbine 110 (or turbine 128).

In aquifer-based system 102a, for example, the valve 602a is above, but near, the pump-turbine 110. In a typical implementation, this valve 602a can be closed after the pump-turbine 110 has stopped pumping in order to maintain a head of fluid in the fluid communication channel above the valve 602a.

When the aquifer-based system 102a receives a command to start producing electricity, the valve 602a can be opened to release the fluid above the valve 602a to drive the pump-turbine 110 for electrical generation purposes. Since the valve 602a is very close to the pump-turbine 110 (e.g., within about one or two feet, for example), the fluid that is released when the valve is open reaches the pump-turbine 110 very quickly.

Thus, the aquifer-based system 102a can begin producing electricity nearly immediately (or with very little delay) upon an indication that electricity production is desired.

Aquifer-based system 102b is similar to aquifer-based system 102a, except that the valve 602b in aquifer-based system 102b is below the pump-turbine 110. Thus, when the valve 602a is closed, for example, after the pump-turbine 110 has stopped pumping, the system 102b maintains a head of fluid in the pump-turbine 110 itself as well as in the fluid communication channel above the pump-turbine 110.

When the aquifer-based system 102b receives a command to start producing electricity, the valve 602b can be opened to release the fluid above the valve 602b to drive the pump-turbine 110 for electrical generation purposes. Since the valve 602b is below the pump-turbine 110, the fluid begins flowing through the pump-turbine 110 almost virtually immediately.

Thus, the aquifer-based system 102b can begin producing electricity nearly immediately (or with very little delay) upon an indication that electricity production is desired.

In aquifer-based system 102n, the valve is located below the turbine 128 and is operable in a similar manner as the valve 602b in aquifer-based system 102b.

In a typical implementation, with an aquifer-based system primed (with fluid very close to or inside and above a pump-turbine or turbine) to begin producing electricity nearly immediately, the amount of time that irrigation may need to be interrupted in order to produce a requisite amount of electricity may be reduced. In some instances, the shorter duration of interruption to irrigation may make the interruption more acceptable to the owner or operator of the irrigation system than a longer duration interruption would be.

In the illustrated implementation, each valve 602a, 602b . . . 602n is configured so that it can be opened or closed from a corresponding one of the local controllers 122. Moreover, in a typical implementation, all of the valves 602a, 602b . . . are configured so that they can be opened or closed from the central/remote controller 104.

In some implementations, the valves can be integrated into the turbine or pump-turbine.

A number of embodiments of the invention have been described. Nevertheless, it will be understood that various modifications may be made without departing from the spirit and scope of the invention.

For example, multiple aquifer-based systems can be coupled to a single aquifer. Additionally, some aquifer-based systems may remove fluid from one aquifer and return the fluid to a different aquifer. Moreover, multiple aquifers from different aquifer-based systems can share a single pumped-storage container.

Moreover, specific design and arrangement and interaction of components can vary in a given aquifer-based system and in a given network.

Additionally, some of the aquifer-based systems in a network may have only one purpose (i.e., to generate electricity).

Each local controller may comprise several different physical components (e.g., control panels), with the functionality associated with each local controller distributed across the different physical components. Similarly, each central controller may include several different physical components, with the functionality associated with the central controller distributed across the different physical components.

The function performed by the aquifer-based system that is not related to the pumped-storage generation function can be irrigation or any other function that uses fluid. Therefore, in some implementations, the multiple uses can include pumped-storage hydroelectric generation and some other use besides irrigation that is substantially unrelated to the pumped-storage hydroelectric generation. However, in general, the multiple uses will include at least some form of pumped-storage hydroelectric generation.

The order of steps in functions and processes described herein can vary considerably. Indeed, in some instances, one or more steps may be omitted completely.

The techniques disclosed herein can be implemented with various types of aquifers including, for example, saturated and unsaturated aquifers, as well as confined and unconfined aquifers. One or more of the aquifers can be man-made.

Additionally, the bore holes that house some of the components disclosed herein can have different sizes and shapes. Some components including, for example, parts of the fluid communication channel(s) may be located above ground. Some implementations may include multiple pumps and/or multiple turbines associated with a single fluid communication channel. The valves in the fluid communication channels may be configured in a variety of ways. Multiple valves may be situated at different sections in each fluid communication channel.

Moreover, the generator can be adapted to synchronize and connect to the electrical supply system in a variety of ways. In some implementations, synchronization and connection is automated and controlled, for example, by the local or remote controller.

Accordingly, other implementations are within the scope of the claims.

What is claimed is:

1. A method of operating an aquifer-based system, the method comprising:
pumping fluid out of an aquifer with a pump; and
selectively diverting the pumped fluid:
to a pumped-storage reservoir for subsequent return to the aquifer through a turbine to generate electricity hydroelectrically; or
to a fluid-utilizing system configured to utilize the pumped fluid in an application that is not related to the hydroelectric generation.

2. The method of claim 1 further comprising:
providing an indication at a remotely-located indicator as to whether the aquifer-based system is available to generate electricity hydroelectrically.

3. The method of claim 2 wherein the availability of the aquifer-based system to generate electricity hydroelectrically depends, at least in part, on whether the pump is currently pumping the fluid out of the aquifer.

4. The method of claim 2 wherein the availability of the aquifer-based system to generate electricity hydroelectrically depends, at least in part, on whether a local operator has reserved the aquifer-based system, at a local controller, for use in connection with the fluid-utilizing system only.

5. The method of claim 2 further comprising:
providing a remotely-located controller that can be manipulated to cause a portion of the pumped fluid in the pumped-storage reservoir to return to the aquifer through the turbine substantially under the influence of gravity, if the aquifer-based system has been indicated as being available to generate electricity hydroelectrically.

6. The method of claim 5 further comprising:
releasing the portion of the pumped fluid in the pumped-storage container to return to the aquifer through the turbine and thereby generate electricity in response to a manipulation of the remotely-located controller.

7. The method of claim 5 further comprising:
preventing the remotely-located controller from causing the portion of the pumped fluid in the pumped-storage reservoir to return the aquifer through the turbine, unless the aquifer-based system has been indicated as being available to generate electricity hydroelectrically.

8. The method of claim 1 wherein selectively diverting the pumped fluid comprises:
configuring one or more valves connected between the pump and the pumped-storage reservoir and between the pump and the fluid-utilizing system.

9. The method of claim 1 further comprising:
timing operation of the pump to pump the aquifer fluid to the pumped-storage reservoir when off-peak rates apply for the purchase of electrical power to run the pump.

10. The method of claim 1 wherein the fluid-utilizing system is selected from the group consisting of an irrigation system, a drinking water system, a heating water system and a cooling water system.

11. The method of claim 1 wherein the pump and the turbine are the same machine and wherein the return of fluid to the aquifer through the turbine to generate electricity hydroelectrically comprises allowing the fluid to flow through and drive the pump.

12. The method of claim 1 wherein the aquifer is a naturally-occurring layer of porous substrate configured to contain and transmit groundwater and wherein the pumped-storage reservoir is a manufactured container or a natural body of fluid.

13. The method of claim 1 further comprising maintaining a head of fluid in at least part of a fluid communication channel above the pump after the pumping has stopped.

14. A system comprising:
an aquifer;
a pump configured to pump fluid out of the aquifer;
a valve assembly configured to selectively divert the pumped fluid:
to a pumped-storage reservoir for subsequent return to the aquifer through a turbine-generator for hydroelectric generation; or
to a fluid-utilizing system configured to utilize the fluid in an application that is not related to the hydroelectric generation.

15. The system of claim 14 further comprising:
a remotely-located indicator to provide an indication as to whether the aquifer-based system is available to generate electricity hydroelectrically.

16. The system of claim 15 wherein the availability of the aquifer-based system to generate electricity hydroelectrically depends, at least in part, on whether the pump is currently pumping the fluid out of the aquifer.

17. The system of claim 15 wherein the availability of the aquifer-based system to generate electricity hydroelectrically depends, at least in part, on whether a local operator has reserved the aquifer-based system, at a local controller, for use in connection with the fluid-utilizing system only.

18. The system of claim 17 further comprising:
the local controller to enable the local operator to reserve the aquifer-based system for use in connection with the fluid-utilizing system only.

19. The system of claim 15 further comprising:
a remotely-located controller that can be manipulated to cause a portion of the pumped fluid in the pumped-storage reservoir to return to the aquifer through the turbine substantially under the influence of gravity, if the aquifer-based system has been indicated as being available to generate electricity hydroelectrically.

20. The system of claim 19 wherein the valve assembly is configured to release the portion of the pumped fluid in the pumped-storage container to return to the aquifer through the turbine and thereby generate electricity in response to a manipulation of the remotely-located controller.

21. The system of claim 15 wherein the remotely-located controller is prevented from causing the portion of the pumped fluid in the pumped-storage reservoir to return the aquifer through the turbine, unless the aquifer-based system has been indicated as being available to generate electricity hydroelectrically.

22. The system of claim 14 wherein the valve assembly comprises one or more valves connected between the pump and the pumped-storage reservoir and between the pump and the fluid-utilizing system.

23. The system of claim 14 wherein the system is configured so that the pump operates to pump the aquifer fluid to the pumped-storage reservoir when off-peak rates apply for the purchase of electrical power to run the pump.

24. The system of claim 14 wherein the fluid-utilizing system is selected from the group consisting of an irrigation system, a drinking water system, a heating water system and a cooling water system.

25. The system of claim 14 wherein the pump and the turbine are the same machine and wherein the return of fluid to the aquifer through the turbine to generate electricity hydroelectrically comprises allowing the fluid to flow through and drive the pump.

26. The system of claim 14 wherein the aquifer is a naturally-occurring layer of porous substrate configured to contain and transmit groundwater and wherein the pumped-storage reservoir is a manufactured container or a natural body of fluid.

27. The system of claim 14 further comprising:
a valve that is operable to maintain a head of fluid in at least part of (or all of) the fluid communication channel above the pump-turbine 110 when the pump is idle.

28. A network comprising:
a plurality of aquifer-based systems, each aquifer-based system comprising:
an aquifer;
a pump configured to pump fluid out of the aquifer;
a valve assembly configured to selectively divert the pumped fluid:
to a pumped-storage reservoir for subsequent return to the aquifer through a turbine-generator for hydroelectric generation; or
to a fluid-utilizing system configured to utilize the pumped fluid in an application that is not related to the hydroelectric generation; and
a central controller coupled to the aquifer-based systems,
wherein the central controller is configured to determine whether one or more of the aquifer-based systems is available to generate electricity hydroelectrically.

29. The network of claim 28 further comprising:
a remotely-located indicator to provide an indication as to whether each of the aquifer-based systems is available to generate electricity hydroelectrically.

30. The network of claim 29 wherein the availability of each aquifer-based system to generate electricity hydroelectrically depends, at least in part, on whether the pump of that aquifer-based system is currently pumping the fluid out of the aquifer.

31. The network of claim 29 wherein the availability of each aquifer-based system to generate electricity hydroelectrically depends, at least in part, on whether a local operator has reserved that aquifer-based system, at a local controller, for use in connection with the fluid-utilizing system only.

32. The network of claim 31 further comprising:
the local controller to enable the local operator to reserve the aquifer-based system for use in connection with the fluid-utilizing system only.

33. The network of claim 29 wherein the central controller is able to be manipulated to cause in one or more of the aquifer-based systems that have been indicated as being available to generate electricity:
a portion of the pumped fluid in the pumped-storage reservoir to return to the aquifer through the turbine substantially under the influence of gravity.

34. The network of claim 33 wherein, in each of the aquifer-based systems:
the valve assembly is configured to release the portion of the pumped fluid in the pumped-storage container to return to the aquifer through the turbine and thereby generate electricity in response to a manipulation of the central controller.

35. The network of claim 29 wherein, for each aquifer-based system that has not been indicated as being available to generate electricity hydroelectrically:
the central controller is prevented from causing the portion of the pumped fluid in the pumped-storage reservoir to return the aquifer through the turbine.

36. The network of claim 28 wherein, for each aquifer-based system, the valve assembly comprises one or more valves connected between the pump and the pumped-storage reservoir and between the pump and the fluid-utilizing system.

37. The network of claim 28 wherein, for each aquifer-based system, the aquifer-based system is configured so that the pump operates to pump the aquifer fluid to the pumped-storage reservoir when off-peak rates apply for the purchase of electrical power to run the pump.

38. The network of claim 28 wherein, for each aquifer-based system, the fluid-utilizing system is selected from the group consisting of an irrigation system, a drinking water system, a heating water system and a cooling water system.

39. The network of claim 28 wherein, for one or more of the aquifer-based systems, the pump and the turbine are the same machine such that the return of fluid to the aquifer through the turbine to generate electricity hydroelectrically comprises the fluid flowing through and driving the pump.

40. The network of claim 28 wherein the aquifer is a naturally-occurring layer of porous substrate configured to contain and transmit groundwater and wherein the pumped-storage reservoir is a manufactured container or a natural body of fluid.

41. The network of claim 28 wherein the central controller is configured to operate more than one of the aquifer-based systems to generate electricity hydroelectricity at the same time.

42. A method comprising:
identifying an existing system configured to pump fluid out of an aquifer to a fluid-utilizing system;
providing a pumped-storage container at an elevation higher than the fluid in the aquifer; and
providing a valve assembly to selectively divert fluid pumped by the pump:
to the pumped-storage reservoir for subsequent return to the aquifer through a turbine-generator for hydroelectric generation; or
to the fluid-utilizing system,
wherein the fluid-utilizing system is configured to utilize the pumped fluid in an application that is not related to the hydroelectric generation.

43. The method of claim 42 further comprising:
providing a remotely-located indicator to indicate whether the aquifer-based system is available to generate electricity hydroelectrically.

44. The method of claim 43 wherein the availability of the aquifer-based system to generate electricity hydroelectrically depends, at least in part, on whether the pump is currently pumping the fluid out of the aquifer.

45. The method of claim 43 wherein the availability of the aquifer-based system to generate electricity hydroelectrically depends, at least in part, on whether a local operator has reserved the aquifer-based system, at a local controller, for use in connection with the fluid-utilizing system only.

46. The method of claim 43 further comprising:
providing a remotely-located controller that can be manipulated to cause a portion of the pumped fluid in the pumped-storage reservoir to return to the aquifer through the turbine substantially under the influence of gravity, if the aquifer-based system has been indicated as being available to generate electricity hydroelectrically.

47. The method of claim 46 further comprising:
releasing the portion of the pumped fluid in the pumped-storage container to return to the aquifer through the turbine and thereby generate electricity in response to a manipulation of the remotely-located controller.

48. The method of claim 46 further comprising:
preventing the remotely-located controller from causing the portion of the pumped fluid in the pumped-storage reservoir to return the aquifer through the turbine, unless the aquifer-based system has been indicated as being available to generate electricity hydroelectrically.

49. The method of claim 42 further comprising:
timing operation of the pump to pump the aquifer fluid to the pumped-storage reservoir when off-peak rates apply for the purchase of electrical power to run the pump.

50. The method of claim 42 wherein the fluid-utilizing system is selected from the group consisting of an irrigation system, a drinking water system, a heating water system and a cooling water system.

51. The method of claim 42 wherein the pump and the turbine are the same machine and wherein the return of fluid to the aquifer through the turbine to generate electricity hydroelectrically comprises allowing the fluid to flow through and drive the pump.

52. The method of claim 42 wherein the aquifer is a naturally-occurring layer of porous substrate configured to contain and transmit groundwater and wherein the pumped-storage reservoir is a manufactured container or a natural body of fluid.
